(19) United States
(12) Patent Application Publication
(10) Pub. No.: US 2023/0100685 A1
(43) Pub. Date: Mar. 30, 2023

(54) FINANCIAL PRODUCT INFORMATION COLLECTING PLATFORM SYSTEM, FINANCIAL PRODUCT INFORMATION COLLECTING METHOD, AND COMPUTER PROGRAM FOR THE SAME

(71) Applicant: COOCON CO., LTD., Seoul (KR)

(72) Inventors: Dong Su LEE, Seoul (KR); Bo Hee NAM, Gyeonggi-do (KR); Dong Hyeok YANG, Seoul (KR)

(21) Appl. No.: 17/561,194

(22) Filed: Dec. 23, 2021

(30) Foreign Application Priority Data
Sep. 30, 2021 (KR) 10-2021-0129478

(51) Int. Cl. G06Q 30/06; G06F 40/247; G06F 16/35; G06F 16/951

(52) U.S. Cl. CPC G06Q 30/0629; G06F 40/247; G06F 16/35; G06F 16/951

(57) ABSTRACT

A financial product information collecting platform system includes: a data collecting module configured to collect description data of one or more financial products from one or more financial institutions; a data processing module including a financial product database configured to store one or more normalized words and benefit structure information pre-designated in relation to financial products, and a data structurer configured to generate structured financial product information by matching the description data to the one or more normalized words and the benefit structure information; and a data providing module configured to provide the financial product information to a user. The financial product information collecting platform system may perform normalization and structuring by establishing a classification system for unstructured data of terms used to describe financial products and mapping the same or similar words to pre-set terms, and may provide various financial product information in a standardized way by dividing information such as benefits of financial products based on tags.

### CROSS-REFERENCE TO RELATED APPLICATION

This application claims priority to Korean Patent Application No. 10-2021-0129478, filed on Sep. 30, 2021, and all the benefits accruing therefrom under 35 U.S.C. § 119, the contents of which in its entirety are herein incorporated by reference.

### BACKGROUND

### 1. Field

Embodiments relate to a financial product information collecting platform system, a financial product information collecting method, and a computer program for the same. More particularly, embodiments relate to a technology for facilitating general users' recognition and comparison of financial products by normalizing, structuring, and providing information on financial products provided by information holding institutions such as financial institutions on financial products.

### 2. Description of the Related Art

Financial institutions that sell financial products such as deposit accounts, installment savings accounts, loans, insurance, and cards provide various benefits related to interest rates, discounts, or points according to types of products in order to attract customers to subscribe to the products. For example, card companies that issue credit or debit cards competitively develop and release various cards with different benefits such as affiliate member discounts and points, in order to induce card service subscriptions.

Financial products including cards have different conditions such as annual fees and performance required for consumers to enjoy benefits provided by the products, and consumers need to select financial products that fit their savings or consumption patterns.

However, financial institutions often use different expressions to describe their products, or terms for describing products often vary according to product planning and release dates even within the same financial institution. For example, the expression referring to a deposit interest rate may be different as a preferential interest rate or a preferential rate of interest according to a financial institution or a financial product. Accordingly, it is difficult for a consumer to intuitively identify benefits related to each product or to identify a product including desired benefits.

As a technology for facilitating a consumer's comparison of information related to each financial product, Patent Registration No. 10-1890280 discloses a technology for integrating and providing financial product information in an application installed and running on a user terminal and filtering and providing financial product information that meets a specific filter condition value. However, the technology disclosed in Patent Registration No. 10-1890280 simply maps product information to pre-determined detailed items, and does not address normalizing and structuring various financial product information or extracting meaningful information items.

### RELATED LITERATURES

### Patent Literature

(Patent Literature 001) Patent Registration No. 10-1890280

### SUMMARY

The present disclosure is directed to providing a financial product information collecting platform system, a financial product information collecting method, and a computer program for the same, which may perform normalization and structuring by establishing a classification system for unstructured data of terms used to describe financial products and mapping the same or similar words to pre-set terms, and may provide various financial product information in a standardized way by dividing information such as benefits of financial products based on tags.

According to a financial product information collecting platform according to an aspect of the present disclosure, consumers may easily recognize financial product-related information such as preferential interest rate conditions for loan products such as deposit accounts and installment savings accounts or performance conditions for receiving benefits of card products, and thus companies or individuals using financial products may recognize product information of each financial institution in the same sense, an may easily compare various financial products.

Also, according to a financial product information collecting platform according to an aspect of the present disclosure, information that may be utilized from unstructured benefit conditions may be extracted and matched to pre-set tags. Thus, the convenience and consistency of information collected for financial products may be improved, and it is possible to reduce the development difficulty and maximize the development efficiency of a function of recommending financial products to users by matching personal data such as card usage history, assets, and health care data to financial products.

Furthermore, financial institutions that sell financial products frequently change interest rates or benefit conditions according to external circumstances such as a benchmark interest rate. According to a financial product information collecting platform according to an aspect of the present disclosure, the cost and manpower required to update and inspect financial product information may be minimized, by automatically detecting a changed area in a financial product-related web page of a financial institution, discarding junk data in detected changed content, and enabling only meaningful information change of financial products to be identified.

### BRIEF DESCRIPTION OF THE DRAWINGS

FIG. 1 is a block diagram illustrating a financial product information collecting platform system, according to an embodiment.

FIG. 2 is a flowchart illustrating operations of a financial product information collecting method, according to an embodiment.

FIGS. 3A and 3B are conceptual diagrams for describing a process of collecting information from a web page by using a financial product information collecting method, according to an embodiment.

FIG. 4 is a conceptual diagram illustrating a user interface for displaying information of financial product information structured by using a financial product information collecting method, according to an embodiment.

FIG. 5 is a conceptual diagram for describing a process of managing information based on tags by using a financial product information collecting method, according to an embodiment.

FIG. 6 is a conceptual diagram for describing a method of detecting a changed area of information by using a financial product information collecting method, according to an embodiment.

FIG. 7 is a conceptual diagram for describing processing of junk data by using a financial product information collecting method, according to an embodiment.

### DETAILED DESCRIPTION

Embodiments of the present disclosure will be described in detail with reference to the drawings.

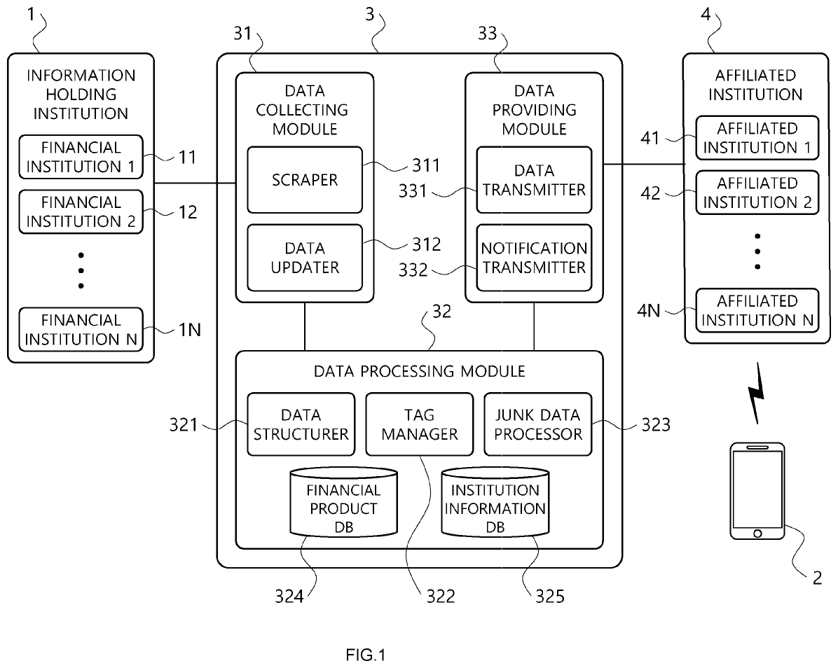

FIG. 1 is a block diagram illustrating a financial product information collecting platform system, according to an embodiment.

Referring to FIG. 1, a financial product information collecting platform system 3 according to the present embodiment is configured to collect information about financial products from an information holding institution 1 and standardize, structure, and provide the information to an affiliated institution 4. The information holding institution 1 that is an institution for providing information related to financial products such as deposit accounts, installment savings accounts, loans, insurance, and cards may refer to a financial institution such as, but not limited to, a bank, an insurance company, or a card company. Also, the financial product information collecting platform system 3 may collect financial product information from a plurality of financial institutions 11, 12, . . . , 1N.

The affiliated institution 4 that is an institution for receiving financial product information from the financial product information collecting platform system 3 and providing the financial product information to a user may be, for example, but is not limited to, a system of a fintech operator or a my data operator. Also, the financial product information collecting platform system 3 may provide financial product information to a plurality of affiliated institutions 41, 42, . . . , 4N. In an embodiment, each of the affiliated institutions 41, 42, . . . , 4N may be an application service server configured to communicate with an application (or app) running on a user device 2 or a web server configured to provide a web page accessible by using a web browser running on the user device 2.

For this operation, the financial product information collecting platform system 3 may be communicatively connected to one or more financial institutions 11, 12, . . . , 1N and one or more affiliated institutions 41, 42, . . . , 4N through a wire and/or wireless network. Also, in an embodiment, the financial product information collecting platform system 3 may be further communicatively connected to the user device 2. In the present embodiment, a communication method through a wired and/or wireless network may be implemented by using an arbitrary communication method capable of networking an object and an object, and examples thereof include, but are not limited to, wired communication, wireless communication, 3G, 4G, and other methods.

Although one user device 2 is illustrated for convenience of explanation, this is merely an example, and it will be easily understood by one of ordinary skill in the art that the number of actual users using a service of the affiliated institution 4 to receive financial product information is not limited.

Also, in an embodiment, the financial product information collecting platform system 3 may be configured to directly provide financial product information to the user. For example, the financial product information collecting platform system 3 may be configured to directly communicate with the user device 2 without through the affiliated institution 4, or the financial product information collecting platform system 3 itself may be implemented as a part of a system of the affiliated institution 4.

Also, devices described herein may be entirely hardware, or may have both hardware and software aspects. For example, the financial product information collecting platform system 3, each institution, system, device, and server communicating with the financial product information collecting platform system 3, and each unit included therein may collectively refer to a device for transmitting and receiving data of a specific format and content through an electronic communication method its related software. In the specification, the term such as “unit”, “module”, “server”, “system”, “platform”, “device”, or “terminal” is indented to indicate a combination of hardware and software driven by the hardware. For example, hardware used herein may be a data processing device including a central processing unit (CPU) or another processor. Also, software driven by hardware may be a running process, an object, an executable file, a thread of execution, or a program.

In an embodiment, the financial product information collecting platform system 3 includes a data collecting module 31, a data processing module 32, and a data providing module 33. In an embodiment, the data collecting module 31 includes a scraper 311 and a data updater 312. Also, in an embodiment, the data providing module 33 includes a data transmitter 331 and a notification transmitter 332. Furthermore, in an embodiment, the data processing module 32 includes a data structurer 321, a tag manager 322, and a financial product database (DB) 324. In an embodiment, the data processing module 32 further includes an institution information DB 325. Furthermore, in an embodiment, the data processing module 32 further includes a junk data processor 323.

In the specification, each module of the financial product information collecting platform system 3 is not necessarily intended to be a physically separated element. That is, although the modules 31-33 constituting the financial product information collecting platform system 3 are illustrated as separate blocks in FIG. 1, the modules are functionally divided by operations executed by the financial product information collecting platform system 3. According to embodiments, some or all of the above modules may be integrated in the same device, or one or more modules may be implemented as physically separated devices from other modules. For example, portions of the financial product information collecting platform system 3 may be components communicatively connected to one another in a distributed computing environment.

The data collecting module 31 may collect description data of financial products from the information holding institution 1 such as one or more financial institutions 11, 12, . . . , 1N. The scraper 311 may receive the description data in a scraping method from web pages provided by the financial institutions 11, 12, . . . , 1N. Also, the data updater 312 may collect updated content of the description data of the financial products through scraping for a scraping area corresponding to each of the financial institutions 11, 12, . . . , 1N.

The data processing module 32 stores one or more normalized words and benefit structure information pre-designated in relation to the financial products in the financial product DB 324. The data structure 321 may generate financial product information in which words used to describe the financial products are standardized and structured by matching the description data collected by the data collecting module 31 to the normalized word and benefit structure information of the financial product DB 324.

In an embodiment, the tag manager 322 may generate information about preferential conditions of the financial products by matching the description data to pre-set tags and sub-items of each tag, and may store the information about the preferential conditions in the financial product DB 324.

In an embodiment, the institution information DB 325 may store scraping area information that defines areas for collecting the description data of the financial products in the web pages provided by the financial institutions 11, 12, . . . , 1N. In this case, the scraper 311 and/or the data updater 312 of the data collecting module 31 may collect the description data from the financial institutions 11, 12, . . . , 1N based on the scraping area information.

In an embodiment, the junk data processor 323 may determine whether changed content of the description data collected from the web pages of the financial institutions 11, 12, . . . , 1N is meaningful changed content. When the changed content is meaningful changed content, the changed description data may be structured as financial product information and may be stored in the financial product DB 324, and when the changed content is not meaningful changed content, the changed content may be discarded. Whether the changed content is meaningful changed content or not may be determined based on an area where change of the description data occurs or characters that define the change of the description data.

The data providing module 33 is configured to provide the structured financial product information, generated by the data processing module 32, to the user. The data transmitter 331 may transmit the financial product information to the affiliated institutions 41, 42, . . . , 4N, or may directly transmit the financial product information to the user device 2. Also, the notification transmitter 332 is configured to transmit, in response to the occurrence of change of the description data of the financial products, a notification of a changed area to a manager. In this case, the manager refers to an operator who operates a financial product information providing service through the financial product information collecting platform system 3.

Also, in this case, when change of the description data occurs, it includes not only a case where existing description of the financial products is modified, but also a case where description data is newly created or existing description data is deleted. That is, in both cases where the financial products are deleted and sales of the financial products are stopped, and sales of new financial products are started, a notification may be transmitted to the manager. When a notification of new description data due to the new financial products is transmitted, a notification of a changed area may include detailed description data of the financial products such as product names.

In an embodiment, the notification transmitter 332 may be configured to transmit a notification of a changed area of description data to the manager, only when it is determined by the junk data processor 323 that changed content is not junk data.

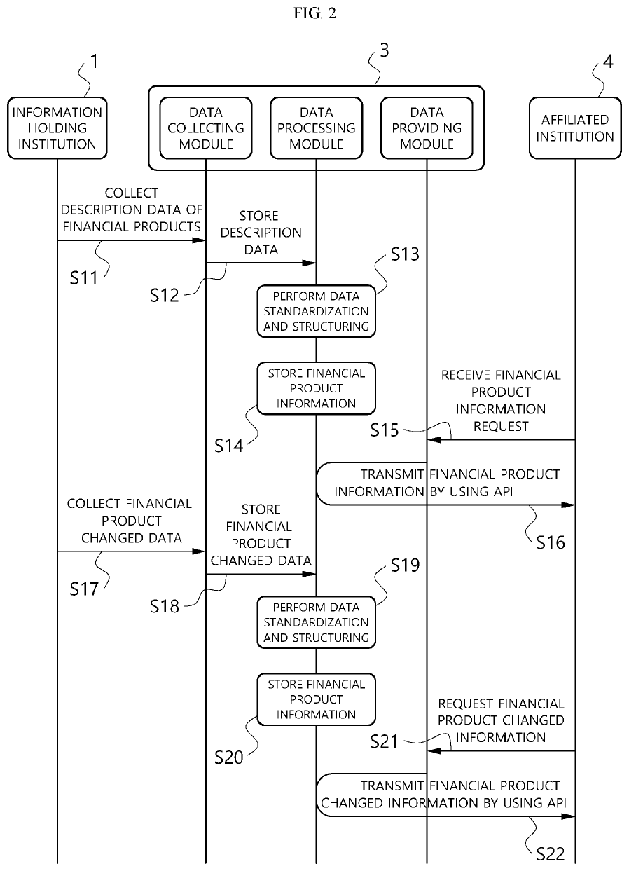

FIG. 2 is a flowchart illustrating operations of a financial product information collecting method, according to an embodiment. A financial product information collecting method according to embodiments may be performed by using a financial product information collecting platform system according to embodiments.

Referring to FIG. 2, a data collecting module of the financial product information collecting platform system 3 may collect description data of financial products from the information holding institution 1 (S11), and may store the collected description data in a data processing module (S12). For example, the data collecting module may collect the description data by scraping a specific area of a web page of a financial institution.

As such, because the collected description data is unstructured data and definitions and uses of terms are often different according to financial institutions providing financial products, a data processing module of the financial product information collecting platform system 3 may generate financial product information by performing data standardization and structuring by establishing a classification system for unstructured data and mapping the same or similar text and words to pre-set terms (S13). Also, the generated financial product information may be stored in a financial product DB of the data processing module (S14).

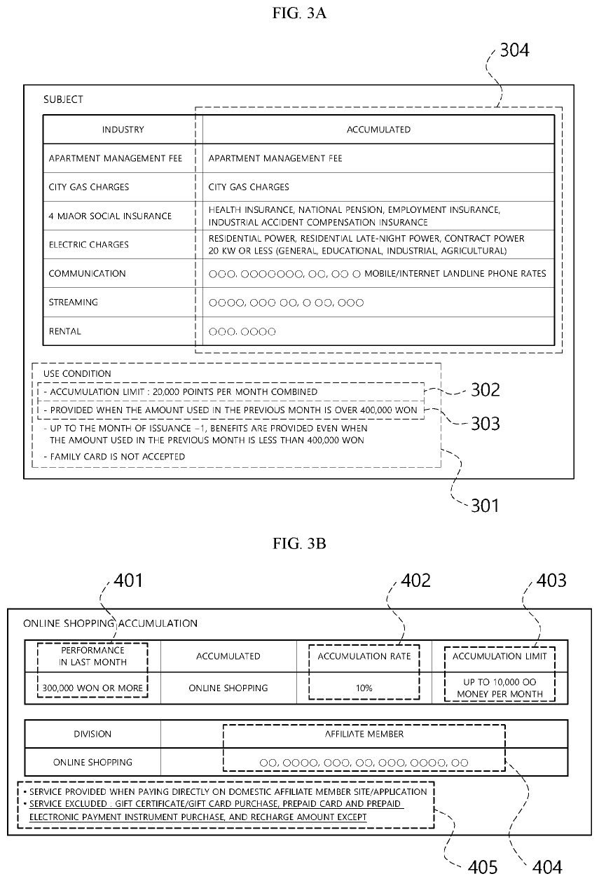

FIGS. 3A and 3B are conceptual diagrams for describing a process of collecting information from a web page by using a financial product information collecting method, according to an embodiment.

First, FIG. 3A is a diagram illustrating a web page in which benefits of accumulating service points when a living fee is automatically paid with a card are announced, to describe description data that defines benefits of ‘accumulating’ for a ‘card’ financial product. A financial product information collecting platform system may collect the description data from the web page. For example, the description data collected by the financial product information collecting platform system may include use condition information 301 and benefit affiliate member information 304. Also, the use condition information 301 may include information such as a point accumulation limit 302 and a performance amount 303 for enjoying benefits.

Alternatively, FIG. 3B illustrates a web page for describing accumulation benefits for an online shopping usage amount of a card. The financial product information collecting platform system may collect use condition information such as a performance amount 401 and particular details excluding benefits 405, benefit information such as an accumulation rate 402 and an accumulation limit 403, and benefit affiliate member information 404.

The financial product information collecting platform system may standardize and structure information of financial products by using description data collected by using the method described with reference to FIGS. 3A and 3B.

In detail, the financial product information collecting platform system may group the same or similar words or sentences based on pre-set synonym information in description data collected from various financial institutions and/or collected for various financial products, and may set normalized words representing each group. Because terms used to describe the same financial product characteristics may be different according to financial institutions, the terms may be matched to normalized words set in the financial product information collecting platform system.

For example, examples of normalized words in the financial product information collecting platform system according to an embodiment and terms mapped to the normalized words are as shown in Table 1.

TABLE 1

| Described | Term Example | Term Example | Term Example | Normalized |
|---|---|---|---|---|
| characteristics | 1 | 2 | 3 | Words |
| Tax-free | Tax benefits | Tax | Tax related | Non-tax |
| comprehensive | | | | comprehensive |
| savings | | | | savings |
| possible/impossible | | | | |
| Interest provided | Preferential | Preferential | Preferential | Preferential |
| by financial | interest rate | rate of interest | interest | interest rate |
| product | | | | |
| Interest paid after | Maturity | Interest paid | Final interest | Highest interest |
| product expiration | interest rate | after maturity | | rate |
| | Interest rate | Interest after | | Interest rate |
| | after maturity | maturity | | after maturity |
| Prerequisites for | Common guide | Common | Use guide | Particular |
| using product | | notable points | | points |
| Performance | Amount used | Usage amount | Amount used | Performance |
| condition for | in the last | | in the previous | amount |
| benefits | month | | month | |

The generated normalized words may be stored in a financial product DB of the financial product information collecting platform system. However, the characteristics and normalized words of a financial product in the above table are merely an example, and forms of normalized words set by the financial product information collecting platform system are not limited thereto.

Also, the financial product information collecting platform system may categorize benefits provided according to financial products and/or according to financial institutions. For example, ‘discount’ that is one of benefits of a card financial product may be expressed in various ways as discount, billing discount, payment day discount, or discount per case according to financial institutions. Also, ‘discount per liter’ that is one of discounts may be expressed in various ways as discount per liter, refueling discount, discount upon refueling, refiner discount, other discount, or gas station discount.

In this case, the financial product information collecting platform system may categorize benefits provided by specific types of financial products into pre-set categories based on description data of the financial products, and may standardize benefit information of the description data through a structuring algorithm for benefits of each category. For example, refueling-related discount of financial products may be categorized into five categories including discount, accumulation, discount per liter, accumulation per liter, and on-site discount, and the financial product information collecting platform system may structure benefit information of financial products by determining each category and information items belonging to each category.

For example, benefits of financial products of FIGS. 3A and 3B are structured, the financial product information collecting platform system may generate benefit structure information by structuring, based on words included in each description data, the benefits with sub-words including benefit method (discount or accumulation), benefit industry and/or group code, benefit affiliate member, maximum monthly accumulated amount, maximum daily accumulated amount, minimum recognized amount per case, maximum recognized amount per case, maximum number of times during a certain period (day/month/year), accumulation date based on a specific amount (accumulated amount per usage amount), accumulation method, and benefit details such as performance amount, accumulation limit by performance, corresponding amount by performance, accumulated amount per case, and accumulation rate per case, and particular points.

The generated benefit structure information may be stored in the financial product DB, and the financial product information collecting platform system may generate financial product information by matching the description data of the financial products to the benefit structure information.

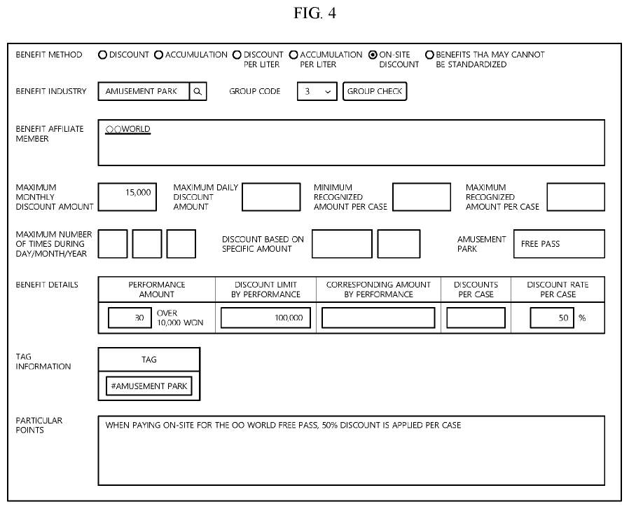

FIG. 4 is a conceptual diagram illustrating a user interface (UI) for displaying financial product information structured by a financial product information collecting method, according to an embodiment.

A financial product information collecting platform system may collect description data of a financial product from a target page of an information holding institution by executing scraping in every pre-set cycle. Next, the financial product information collecting platform system may generate information items of financial product information by matching a pre-set area (e.g., each column) of the description information to normalized words based on words. For example, description data such as tax benefit guide and preferential rate of interest may be matched to normalized words such as fax-free comprehensive savings and preferential interest rate, and information items of financial product information may be determined by using a column value of the description data corresponding to each normalized word.

The structured financial product information may be provided to a user through the UI of FIG. 4. In the example of FIG. 4, information items of financial product information were determined by using industry, affiliate member, benefit method, discount method, and performance amount as normalized words, corresponding words in description data were matched, and thus financial product information including information items of [industry: amusement park], [affiliate member: OO World], [benefit method: on-site discount], [discount method: free pass], [performance amount: 300,000 won], [discount rate per case: 50%] was generated. However, information items of financial product information and types of normalized words corresponding to the information items of the financial product information are not limited to those of FIG. 4.

Also, the financial product information collecting platform system may match the description data to categorized benefits by applying a pre-set benefit category to the information items (i.e., column values of the description data) of the financial product information matched to the normalized words. For example, in the case of a card product, benefits may be categorized into five including discount, accumulation, discount per liter, accumulation per liter, and on-site discount as shown in FIG. 4, but a form of benefit structure information is not limited thereto.

In an embodiment, the financial product information collecting platform system may generate the financial product information by structuring some or all of the financial product information into tags or sub-items corresponding to the tags.

It is assumed that the financial product information collecting platform system manages information about preferential conditions of financial products based on tags. In this case, the financial product information collecting platform system may designate the same or similar conditions in items for preferential conditions in description data of financial products as tags, and may designate detailed conditions included in the preferential conditions for each tag as sub-items of the tag. Such tags and sub-item information may be stored as a part of financial product information in a financial product DB.

For example, in an embodiment using a fixed deposit financial product, examples of tags and sub-items corresponding to each tag are as shown in Table 2.

TABLE 2

| Tag Name | Sub-items | | | | | |
|---|---|---|---|---|---|---|
| New | First | New | First | When having | | |
| | registration of | subscription | transaction | no | | |
| | customer | | | subscription | | |
| | information | | | history | | |
| Re- | New | | | | | |
| subscription | subscription | | | | | |
| | after maturity | | | | | |
| | of deposit | | | | | |
| Re-deposited | Automatically | Re-deposited | | | | |
| | re-deposited | after maturity | | | | |
| Non-fact-to- | Internet/smart | Our app | Telebanking | | | |
| face | banking | subscription | | | | |
| subscription | subscription | | | | | |
| Receiving | Hold other | New | Simultaneous | | | |
| subscription | product | subscription to | subscription | | | |
| | | other product | and maintain | | | |
| | | | until | | | |
| | | | expiration | | | |
| Subscription | Subscription | Housing | | | | |
| savings | savings | subscription | | | | |
| Bank use | Transfer | Our app login | | | | |
| history | details | | | | | |
| Electronic | Phone | Internet | Our app | | | |
| banking | banking | banking | transfer results | | | |
| | transfer results | transfer results | | | | |
| Card | | | | | | |
| performance | | | | | | |
| Automatic | Management | Communication | Insurance fee | City gas | Electric | Subscription |
| transfer | fee | fee | | charges | charges | fee |
| Salary transfer | Salary transfer | Salary transfer | | | | |
| | results | account | | | | |
| | | registration | | | | |
| Pension | Pension | Pension receipt | | | | |
| | receipt | results | | | | |
| | account | | | | | |
| | registration | | | | | |
| Deposit | Average | Deposit over | | | | |
| holding | balance | certain amount | | | | |
| | | when newly | | | | |
| | | subscribed | | | | |
| Open banking | Open baking | Other bank | | | | |
| | subscription | account | | | | |
| | | registration | | | | |
| Soldier | | | | | | |
| Marketing | | | | | | |
| consent | | | | | | |
| Interest | Point | Simple | Other product | | | |
| amount | accumulation | payment | transfer | | | |
| movement | | charging | | | | |
| Eco-friendly | Use of public | Use of eco- | Participation | Join cycling | | |
| | transport | friendly vehicle | in carbon | group | | |
| | | | point system | | | |
| Long-term | | | | | | |
| transaction | | | | | | |
| Mission | Lettering on | Recommend | No smoking | Volunteer | | |
| | passbook | product to | | activity | | |
| | | friend | | certificate | | |

The financial product information collecting platform system may compare, based on information about tags and sub-items, each term of description data with tags and/or sub-items when a new financial product occurs, may map a corresponding tag name and a corresponding sub-item, and may store the same as preferential condition information corresponding to the financial product. In the example of FIG. 4, ‘amusement park’ was stored as preferential condition information of a card product. Through this operation, description data in which the same preferential condition but different terms are used may be matched to an upper tag name through sub-items for each tag.

In this case, the financial product information collecting platform system may enable a manager of the financial product information collecting platform system to review information to be stored and then approve and/or modify the information.

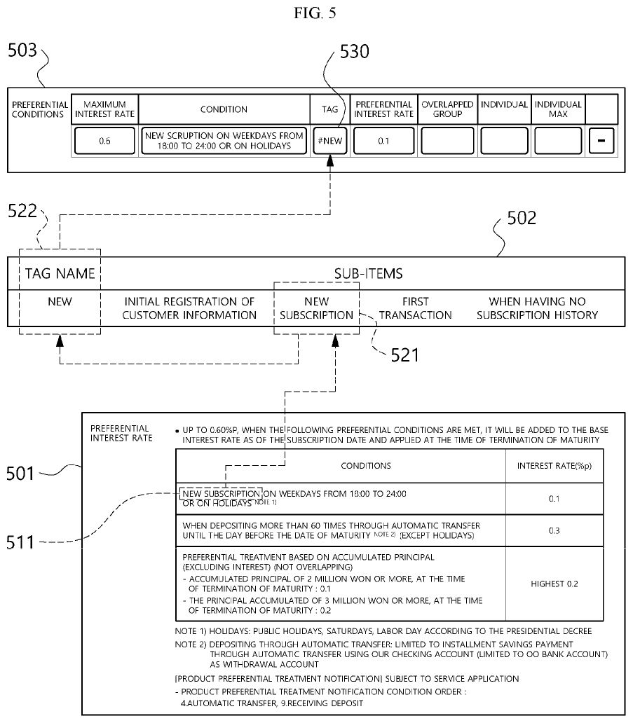

FIG. 5 is a conceptual diagram for describing a process of managing information based on tags by using a financial product information collecting method, according to an embodiment.

Referring to FIG. 5, it is assumed that a phrase 511 ‘when newly subscribed’ exists in description data 501 of a financial product. In this case, a financial product information collecting platform system may compare preferential condition information 502 including a tag and sub-items in a financial product DB with the phrase 511 ‘when newly subscribed’, and may designate ‘new subscription’ 521 that is a sub-item similar to the phrase 511 and ‘new’ 522 that is a tag corresponding to the sub-item for the financial product. Tag information 530 including the tag 522 and the sub-item 521 may be stored as preferential condition information 503 included in financial product information in the financial product information collecting platform system.

Referring back to FIG. 2, a data providing module of the financial product information collecting platform system 3 may receive a financial product information request of the affiliated institution (S15), and may provide structured financial product information in response to the financial product information request. For example, the data providing module may transmit a financial product information API to the affiliated institution 4 so that the affiliated institution 4 accesses the financial product DB of the data processing module by using the API (S16). However, this is merely an example, and in another embodiment, the data providing module may directly extract information requested by the affiliated institution 4 from the financial product information stored in the financial product DB and may provide the information to the affiliated institution 4.

Although an embodiment of transmitting the financial product information to the affiliated institution 4 that provides a service to a user is illustrated in FIG. 2, this is merely an example, and in another embodiment, the financial product information collecting platform system 3 may directly transmit the financial product information to a user device of the user who wants to inquire about the financial product information.

Even after the financial product information is collected and structured, the financial product information collecting platform system 3 may continuously detect changed content of financial product description provided by financial institutions. To this end, the data collecting module of the financial product information collecting platform system 3 may receive change details in financial product description data from the information holding institution 1 through a method such as scraping (S17), and the received change details are referred to as financial product changed data in the specification.

The data collecting module of the financial product information collecting platform system 3 may store the financial product changed data in the financial product DB (S18), and the data processing module may perform standardization and structuring on the changed data in the same manner as the standardization and structuring of operation S13 (S19). Financial product information generated as a result may be stored in the financial product DB to replace or update information previously stored in the financial product DB of the financial product information collecting platform system 3 (S20).

Next, when the affiliated institution 4 or the user requests the financial product information collecting platform system 3 for the financial product changed information (S21), the data providing module of the financial product information collecting platform system 3 may provide the financial product changed information to the user by transmitting the API through which the affiliated institution 4 or the user may access changed financial product information (S22).

To keep information related to various financial products of many financial institutions up to date requires high costs such as manpower input and hardware allocation, and in particular, there is a problem in that a lot of manpower is assigned to an inspection work to inspect the update of financial product information. In order to solve the problem, the financial product information collecting platform system in an embodiment may automatically detect change details in a web page that describes financial products, so that a manager does not need to directly search the page.

Also, the financial product information collecting platform system may transmit a notification of a changed area of the web page to the manager. Furthermore, when the financial product information collecting platform system transmits the notification of the changed area, the financial product information collecting platform system may determine that changed content that is not meaningful changed content in information is junk data and may not transmit a notification of the changed content, thereby preventing unnecessary efforts.

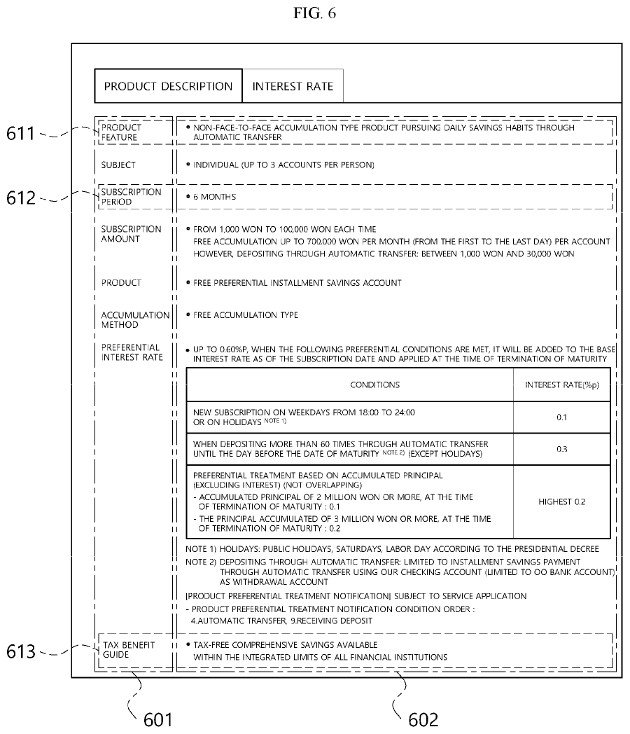

FIG. 6 is a conceptual diagram for describing a method of detecting a changed area of information by using a financial product information collecting method, according to an embodiment.

Referring to FIG. 6, a financial product information collecting platform system may sub-divide, in a web page of financial products provided by each financial institution, only a portion where substantial description of financial products is provided, other than a frame of the web page, a background, or a log area of the financial institution that is not related to financial products into one or more scraping areas, and may store position information of each area in the institution information DB 325 (see FIG. 1) of the financial product information collecting platform system. For example, the financial product information collecting platform system may divide a web page illustrated in FIG. 6 into a title area 601 and a content area 602.

In this case, the financial product information collecting platform system may match data scraped from the title area 601 to normalized words stored in the financial product DB 324 (see FIG. 1) of the financial product information collecting platform system, and may store description data of the content area 602 corresponding to each title area 601 in a financial product DB. In this case, the stored description data may include, but is not limited to, product feature information 611, subscription period information 612, and tax-free comprehensive savings information 613 mapped to the normalized words.

In an embodiment, when change of the description data occurs when compared to description data previously stored for a scraping area of FIG. 6, the financial product information collecting platform system may transmit a notification about a changed area to a manager of the financial product information collecting platform system. In this case, the transmitted notification may include identification information such as a unique number, classification, an institution name, or a product name of a target financial product with the changed area, a state value (e.g., change, new, or delete) of the changed area, and information such as a registration date and/or a modification date of corresponding financial product information.

The notification may be transmitted in any of various methods such as, but not limited to, a text message, an email, or a push notification through an application which may be received by a user device of the manager.

The manager receiving the notification may access the financial product information collecting platform system, may identify the changed area of the description data of the financial product, and may cause the changed content to be reflected in financial product information of the financial product DB through approval and/or modification of data items.

When a web page of a financial institution changes, it may be due to meaningful changed content in substantial benefits or content of products, or it may be due to unmeaningful changed content in relation to financial products such as simple date change or spacing or spelling change. However, because tracking and managing all minor changes in description data of financial products is labor and cost intensive, the financial product information collecting platform system in an embodiment may perform a different operation according to whether changed content of the description data are unmeaningful data (i.e., junk data) in relation to the financial products.

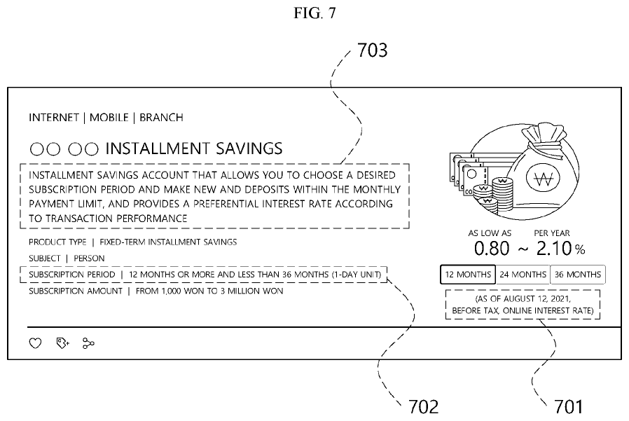

FIG. 7 is a conceptual diagram for describing processing of junk data by using a financial product information collecting method, according to an embodiment.

Referring to FIG. 7, scraping areas 701-703 in a web page that describes a financial product may be divided into information areas and junk data areas according to types, and position information corresponding to each area in each web page of a financial institution may be previously stored in the institution information DB 325 (see FIG. 1) of a financial product information collecting platform system. For example, the area 703 that summarizes description of the financial product and the area 702 that defines a subscription period of the product may correspond to information areas, and the area 701 that displays a reference date may correspond to a junk data area.

In this case, the financial product information collecting platform system may detect an area where change occurs in the web page by comparing description data previously stored in the financial product information collecting platform system with new data of the web page, and may determine whether to transmit a notification according to a type of the area where change occurs. For example, when the area where change occurs is a scraping area that is not an information area, the financial product information collecting platform system may not transmit a notification of the changed area to a manager. For example, when a number of the area 701 that displays the reference date of FIG. 7 changes from 2021. 08. 11. to 2021. 08. 12., the financial product information collecting platform system does not transmit a notification to the manager.

However, in another embodiment, whether changed content is junk data may be determined based on characters for defining change of description data. For example, when change occurs in an information area of a web page but changed content is related to specific characters (including spaces) when compared to previously stored content in the financial product information collecting platform system, the financial product information collecting platform system may determine that the changed content is junk data. For example, when ‘12 months or more’ in the area 702 that defines the subscription period of FIG. 7 changes to ‘12 months or more’, it may be description data change of an information area but addition of a space is not meaningful changed content, and thus the financial product information collecting platform system may determine that the changed content is junk data.

For example, when a length of changed (newly added or deleted) characters is less than 2 characters, the financial product information collecting platform system may determine that it is junk data regardless of changed content. Alternatively, when changed characters are changed only in positions in existing description data without changing other characters of the description data, the financial product information collecting platform system may determine that it is junk data. When ‘payment monthly limit’ in the area 703 that summarizes the description of the financial product of FIG. 7 changes to ‘monthly payment limit’, it may be description data change of an information area but simple word order change occurs, and thus the financial product information collecting platform system may determine that changed content is junk data.

In an embodiment, the junk data processor 323 (see FIG. 1) of the financial product information collecting platform system may be further configured to determine whether changed content is junk data by performing machine learning-based artificial intelligence training by using change details occurring in a junk data area and change details occurring in an information area. First, the junk data processor may generate junk data classification rules through machine learning using change details occurring in the junk data area as an input value. Next, the junk data processor may apply the generated classification rules to changed content in the information area, and may classify a portion of the changed content of the information area corresponding to junk data. For example, it is assumed that the area 701 that displays the reference date of FIG. 7 corresponds to a junk data area, not an information area, and ‘current’ in the area 701 repeatedly changes to ‘as of’. In this case, the junk data processor may generate classification rules stating that interchange between ‘current’ and ‘as of’ corresponds to junk data through machine learning using changed content of the area 701 as an input value. Next, even when interchange occurs between ‘current’ and ‘as of’ in an information area, not a junk data area, the junk data processor may determine that changed content is junk data by processing the classification rules.

Types of junk data classification rules generated through artificial intelligence training are not limited thereto. For example, in the case of a card product, changed content in an area indicating that a traffic card may be applied for or not may correspond to junk data. In this case, the junk data processor may be trained about changed content indicating whether a traffic card is applied for using classification rules, may apply the classification rules to data determination criteria of an information area, even when ‘postpaid transportation’ is created or changed in the information area, may determine that the changed content is junk data, and may not transmit a notification to the manager. Various other junk data classification rules may be generated according to embodiments.

Furthermore, junk data classification rules generated through artificial intelligence training are not limited to those based on creation, deletion, or change of words, and any display form change such as creation, deletion, or change of numbers or spaces, change of a word order, or checking or unchecking of a checkbox may be applied as junk data classification rules through machine learning-based training.

When changed content in description data corresponds to change of a junk data area, the financial product information collecting platform system may store the changed content of the description data in a financial product DB even when a notification is not transmitted to the manager.

Furthermore, types of scraping areas or types of characters for determining junk data are not limited to the above example. Criteria for determining junk data may vary according to embodiments. For example, according to content provided by each financial institution and web page, in the case of an installment savings account, an area that describes automatic re-deposited, partial cancellation, dormant deposit, and contribution may be designated as a junk data area, or in the case of a card, an area that describes viewing product terms and conditions and payment usage fee may be designated as a junk data area.

Operations of the financial product information collecting method according to the above embodiments may be at least partially implemented as a computer program and recorded on a computer-readable recording medium. The computer-readable recording medium on which the program for implementing the operations of the financial product information collecting method according to the embodiments is recorded includes any type of recording device capable storing data readable by a computer. Examples of the computer-readable recording medium include a read-only memory (ROM), a random-access memory (RAM), a compact disk (CD)-ROM, a magnetic tape, a floppy disk, and an optical data storage device. Also, the computer-readable recording medium may be distributed over network coupled computer systems so that computer-readable code is stored and executed in a distributed fashion. Also, functional programs, codes, and code segments for implementing the present embodiment will be readily understood by one of ordinary skill in the art to which the present embodiment belongs.

Also, each block or each operation illustrated in flowcharts of the present specification may represent a part of a module, a segment, or a code, including one or more executable instructions for executing a specific logical function or specific logical functions. It should also be noted that in some alternative embodiments, the functions noted in the blocks or operations may occur out of order. For example, two blocks or operations shown in succession may in fact be executed substantially concurrently or the blocks or operations may sometimes be executed in the reverse order, according to the functionality involved.

While the present disclosure has been particularly shown and described with reference to embodiments thereof, they are provided for the purposes of illustration and it will be understood by one of ordinary skill in the art that various modifications and equivalent other embodiments may be made from the present disclosure. It should be understood that such modifications are included in the technical scope of the present disclosure. Accordingly, the true technical scope of the present disclosure should be determined by the technical spirit of the appended claims.

What is claimed is:

1. A financial product information collecting platform system comprising:
a data collecting module configured to collect description data of one or more financial products from one or more financial institutions;
a data processing module comprising a financial product database configured to store one or more normalized words and benefit structure information pre-designated in relation to financial products, and a data structurer configured to generate structured financial product information by matching the description data to the one or more normalized words and the benefit structure information; and
a data providing module configured to provide the financial product information to a user.

2. The financial product information collecting platform system of claim 1, wherein the benefit structure information comprises one or more tags and sub-items corresponding to each of the one or more tags,
wherein the data processing module further comprises a tag manager configured to generate preferential condition information for the financial products by matching the description data to the one or more tags and the sub-items.

3. The financial product information collecting platform system of claim 1, wherein the data processing module further comprises an institution information database configured to store information of a scraping area pre-set for each of web pages of the one or more financial institutions,
wherein the data collecting module is further configured to collect the description data by using a scraping method from the one or more financial institutions by using the information of the scraping area.

4. The financial product information collecting platform system of claim 3, wherein the data providing module comprises a notification transmitter configured to transmit, in response to an occurrence of change in the description data collected from the scraping area, a notification of a changed area to a manager of the financial product information collecting platform system.

5. The financial product information collecting platform system of claim 4, wherein the data processing module further comprises a junk data processor configured to determine whether changed content of the description data is junk data based on a portion of the scraping area where change of the description data occurs or characters that define change of the description data.

6. The financial product information collecting platform system of claim 5, wherein the notification transmitter is further configured to transmit the notification to the manager only for change of the description data determined to be not junk data by the junk data processor.

7. A financial product information collecting method comprising:
collecting, by a financial product information collecting platform system, description data of one or more financial products from one or more financial institutions;
storing, by the financial product information collecting platform system, one or more normalized words and benefit structure information pre-designated in relation to financial products in the financial product information collecting platform system;
generating, by the financial product information collecting platform system, structured financial product information by matching the description data to the one or more normalized words and the benefit structure information; and
providing, by the financial product information collecting platform system, the financial product information to a user.

8. The financial product information collecting method of claim 7, wherein the benefit structure information comprises one or more tags and sub-items corresponding to each of the one or more tags,
wherein the generating of the financial product information comprises generating, by the financial product information collecting platform system, preferential condition information for the financial products by matching the description data to the one or more tags and the sub-items.

9. The financial product information collecting method of claim 7, further comprising storing, by the financial product information collecting platform system, information of a scraping area pre-set for each of web pages of the one or more financial institutions in the financial product information collecting platform system,
wherein the collecting of the description data comprises receiving, by the financial product information collecting platform system, the description data in a scraping method from the one or more financial institutions by using the information of the scraping area.

10. The financial product information collecting method of claim 9, further comprising, in response to an occurrence of change in the description data collected from the scraping area, transmitting, by the financial product information collecting platform system, a notification of a changed area to a manager of the financial product information collecting platform system.

11. The financial product information collecting method of claim 10, further comprising determining, by the financial product information collecting platform system, whether changed content of the description data is junk data based on a portion of the scraping area where change of the description data occurs or characters that define change of the description data.

12. The financial product information collecting method of claim 11, wherein the transmitting of the notification to a user device comprises transmitting, by the financial product information collecting platform system, the notification to the manager only for change of the description data determined to be not junk data in the determining whether changed content is junk data.

13. A computer program stored in a computer-readable recording medium to perform the financial product information collecting method according to any one of claims 7 through 12 in combination with hardware.
